(19) United States
(12) Patent Application Publication
(10) Pub. No.: US 2018/0132661 A1
(43) Pub. Date: May 17, 2018

(54) APPARATUS AND METHOD FOR COOKING AND FLIPPING

(71) Applicant: GLOBAL CONCEPTS LIMITED, INC., Deerfield Beach, FL (US)

(72) Inventor: Laurie Braden, Boca Raton, FL (US)

(21) Appl. No.: 15/446,653

(22) Filed: Mar. 1, 2017

Related U.S. Application Data
(60) Provisional application No. 62/420,749, filed on Nov. 11, 2016.

(51) Int. Cl. A47J 37/10; A21B 5/03

(52) U.S. Cl. CPC A47J 37/108; A21B 5/03

(57) ABSTRACT

A pancake flipper with a body including a top side and a bottom side opposite the top side; and defining at least one aperture extending from at least the top side through the bottom side, the at least one aperture sized and shaped to receive a batter therein and having: a first diameter defined by a cylindrical sidewall; and a second diameter defined by a lip mechanically coupled to the cylindrical sidewall, the second diameter being less than the first diameter. The pancake flipper further includes at least two handle portions coupled to and separated by the body, each of the at least two handle portions being of a flexible material.

### CROSS-REFERENCE TO RELATED APPLICATION

This application claims priority to U.S. Provisional Patent Application No. 62/420,749 filed on Nov. 11, 2016, the entirety of which is incorporated by reference.

### FIELD OF THE INVENTION

The present invention relates generally to an apparatus and method for cooking and flipping, and, more particularly, a pancake flipper capable of retaining a consumable substance, such as pancake batter, therein for cooking one side on a cooking surface, such as a pan, and flipping the partially cooked consumable substance for cooking on the other side.

### BACKGROUND OF THE INVENTION

When cooking, users often have to flip a consumable substance over in order to cook both sides of the consumable substance. The task of flipping a partially cooked consumable substance poses a challenge for the user. Traditionally, the user can either use a spatula or other kitchen utensil to flip the consumable substance, or can flip the consumable substance over in a cooking surface by flipping the consumable substance into the air, hoping that it lands on its uncooked side. Either way, the user faces a number of problems, such as the consumable substance sticking to the cooking surface, losing portions of the consumable substance over the sides of the cooking surface, or breaking the consumable substance apart by inserting a spatula or other kitchen utensil underneath the consumable substance. These problems can also lead to the uneven or partial cooking of the consumable substance, or the burning of portions of the consumable substance, which can be undesirable and dangerous.

Cooking apparatuses, including cooking surfaces and kitchen utensils, help to alleviate the problems involved with flipping consumable substances over. However, users still face difficulty when cooking partially liquid consumable substances, such as pancake batter or raw eggs, particularly because uncooked liquid consumable substances tend to stick to a cooking surface until at least partially cooking. Moreover, most kitchen utensils are made of two or more materials, with the handle typically being made of a different material than the flipping surface. As a result, it is more difficult to clean and maintain these kitchen utensils, because users must take care to ensure the integrity of varying materials during use and non-use of the kitchen utensils.

Further, users often face difficulty in flipping multiple consumable substances within a single cooking surface for a number of reasons. Because the user must individually flip each consumable substance with a spatula or other kitchen utensil, each consumable substance will cook on a different schedule from the other consumable substances. Moreover, the user must take great care when flipping each consumable substance within the cooking surface, because the user often cannot move the consumable substance after flipping it over without the consumable substance breaking apart. Therefore, if the user flips one consumable substance in the wrong way, the user risks ruining all of the contents of the cooking surface.

Therefore, a need exists to overcome the problems with the prior art as discussed above.

### SUMMARY OF THE INVENTION

The invention provides an apparatus and method for cooking and flipping that can frictionally or mechanically retain a consumable substance, such as pancake batter, and can be rotated, or flipped, about a longitudinal axis defined by an elongated direction of the body of the pancake flipper from a first handle portion to a second handle portion.

With the foregoing and other object in mind, there is provided, in accordance with the invention, a pancake flipper having a body and at least two handle portions. The body includes a top side and a bottom side opposite the top side, and defines at least one aperture extending from at least the top side through the bottom side. The at least one aperture is sized and shaped to receive a batter therein, and includes a first diameter defined by a cylindrical sidewall, and a second diameter defined by a lip that is mechanically coupled to the cylindrical sidewall, with the second diameter being less than the first diameter. The at least two handle portions are coupled to and separated by the body, and each of the at least two handle portions is made of a flexible material.

In accordance with another feature, in one embodiment of the present invention, the body is made of a flexible material that is operably configured to conform to a shape of a cooking surface.

In accordance with a further feature, in one embodiment of the present invention, the body and the at least two handle portions are each made of a heat resistant material.

In accordance with yet another feature, in one embodiment of the present invention, the heat resistant material is non-stick silicone.

In accordance with another characteristic, in one embodiment of the present invention, the cylindrical sidewall measures between 0.5″ and 0.75″ in depth.

In accordance with another feature, in one embodiment of the present invention, the lip extends radially inward of the cylindrical sidewall.

In accordance with a further feature, in one embodiment of the present invention, the cylindrical sidewall includes an optimal content marking indicated an optimum level of the batter to be received within the at least one aperture for cooking and flipping.

In accordance with yet another feature, one embodiment of the present invention includes a rim extending from the top side of the body, and the lip extends from the bottom side of the body.

In accordance with another characteristic, in one embodiment of the present invention, the lip is disposed to mechanically support at least a portion of the batter thereon, and the lip defines at least one aerator hole sized and shaped to create a heat path therethrough from a cooking surface to the at least a portion of the batter supported on the lip.

In accordance with another feature, in one embodiment of the present invention, each of the two handle portions include a hinged portion coupled to the body and a terminal distal gripping portion end opposite the hinged portion.

Also in accordance with the invention, a pancake flipper is disclosed that includes a body having a top side and a bottom side opposite the top side; the body also defines a plurality of apertures extending from at least the top side through the bottom side, each of the plurality of apertures sized and shaped to receive a batter therein and having a first diameter defined by a cylindrical sidewall and a second diameter defined by a lip, the second diameter being less than the first diameter; and the body also includes a rim extending from the top side of the body. The lip extends inward of the cylindrical sidewall and extends from the bottom side of the body. The pancake flipper also includes a first handle portion and a second handle portion opposite the first handle portion, each of the first handle portion and the second handle portion being coupled to and separated by the body.

In accordance with another feature, in one embodiment of the present invention, the body, the first handle portion, and the second handle portion are each made of a heat resistant flexible material.

In accordance with a further feature, in one embodiment of the present invention, the heat resistant flexible material is non-stick silicone.

In accordance with another characteristic, in one embodiment of the present invention, the cylindrical sidewall further includes an optimal content marking indicating an optimum level of the batter to be received within at least one of the plurality of apertures for cooking and flipping.

In accordance with yet another feature, in one embodiment of the present invention, the lip defines a plurality of aerator holes, each of the plurality of aerator holes sized and shaped to create a heat path therethrough from a cooking surface the at least a portion of the batter supported on the lip.

In accordance with another feature, in one embodiment of the present invention, the first handle portion and the second handle portion each include a hinged portion coupled to the body and a terminal distal gripping portion end opposite the hinged portion.

In accordance with the present invention, a method of using a pancake flipper is disclosed, the method comprising the steps of providing a pancake flipper including a body having a top side and a bottom side opposite the top side; the body defining a plurality of apertures extending from at least the top side through the bottom side, each of the plurality of apertures sized and shaped to receive a batter therein and having a first diameter defined by a cylindrical sidewall and a second diameter defined by a lip, the second diameter being less than the first diameter, the lip extending inward of the cylindrical sidewall and extending from the bottom side of the body; the body including a rim extending from the top side of the body. The pancake flipper also includes a first handle portion and a second handle portion opposite the first handle portion, each of the first handle portion and the second handle portion being coupled to and separated by the body. The method also includes the steps of placing the pancake flipper on a cooking surface, such that at least a portion of the lip directly contacts the cooking surface; disposing the batter within at least one of the plurality of apertures, at least a portion of the batter being supported on the lip; gripping the first handle portion and the second handle portion; rotating the pancake flipper about a longitudinal axis to place the pancake flipper in an inverted position; and placing the pancake flipper on the cooking surface, such that at least a portion of the rim directly contacts the cooking surface.

Although the invention is illustrated and described herein as embodied in an apparatus and method for cooking and flipping, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Some detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the body of the pancake flipper from one handle portion to another handle portion.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a top plan view of a pancake flipper, in accordance with an exemplary embodiment of the present invention;

FIG. 2 is a perspective view of the pancake flipper of FIG. 1 in accordance with the present invention;

FIG. 3 is a perspective view the pancake flipper of FIG. 1 in use on a cooking surface in accordance with the present invention;

FIG. 4 is a perspective view of the bottom side of the pancake flipper of FIG. 1 in accordance with the present invention;

FIG. 5 is a flow-chart diagram describing an exemplary method of using the pancake flipper of FIG. 1 in accordance with the present invention; and

FIGS. 6-9 are perspective views illustrating the method of using the pancake flipper of FIG. 1 according to the method described in FIG. 5 in accordance with the present invention.

### DETAILED DESCRIPTION

The present invention provides a novel and efficient pancake flipper. In one embodiment, the pancake flipper is shaped to receive batter for cooking and is operably configured to be inverted, or flipped, about a longitudinal axis defined by an elongated direction of the body of the pancake flipper from one handle portion to the other handle portion. It should be understood that although the term “pancake flipper” is used to describe the present invention, embodiments of the present invention may also be used to cook other non-pancake batter fluid to semi-fluid consumable substances, such as, for example, eggs.

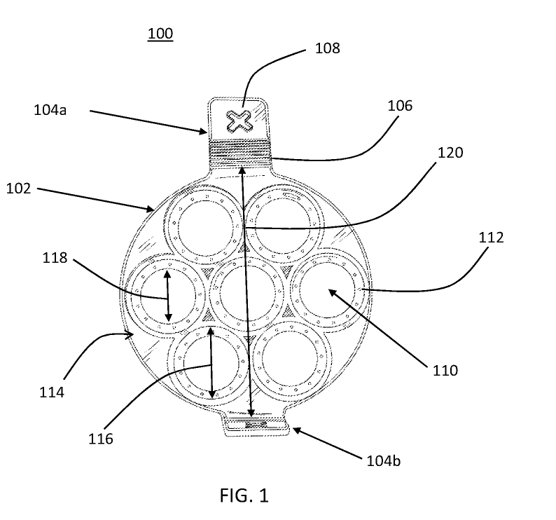

Referring now to FIG. 1, one embodiment of the present invention is shown in a top plan view. FIG. 1 shows several advantageous features of the present invention, but, as will be described below, the invention can be provided in several shapes, sizes, combinations of features and components, and varying numbers and functions of the components. The product may also be used in various applications. The first example of a pancake flipper 100, as shown in FIG. 1, includes a body 102 and at least one handle portion 104 coupled to and separated by the body 102.

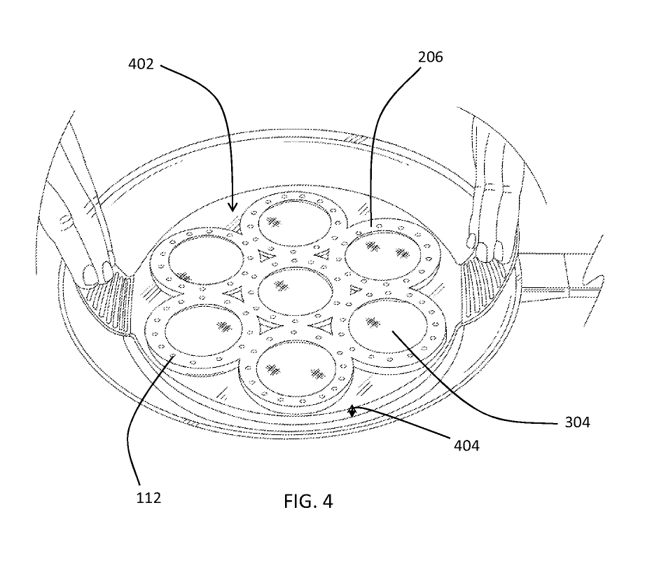

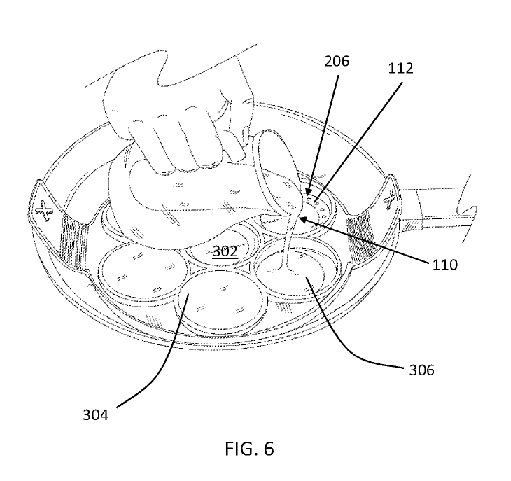

Referring still to FIG. 1, with brief reference to FIG. 4, the body 102 is shown in detail. In one embodiment, the body 102 may include a top side 114 and a bottom side 402 opposite the top side 114, the top side 114 and the bottom side 402 separated by a distance 404 defined by the thickness of the body 102. In one embodiment, the body 102 may be of a consistent thickness. In other embodiments, the body 102 may include varying thicknesses along the length of the body 102. In a preferred embodiment, the body 102 may be made of a heat resistant material to allow the pancake flipper 100 to be used while cooking at high temperatures. As used herein, “heat resistant material” denotes a material that can withstand heat that exceeds the normal temperature of an active cooking surface without any appreciable degradation. Exemplary materials include, but are not limited to, silicone, aluminum, polyurethane, rubber, and the like. For example, in a preferred embodiment, the body 102 of the pancake flipper 100 may be made of non-stick silicone, which is a heat resistant flexible material, and the pancake flipper 100 may be safely used in a dishwasher, microwave, oven, and freezer without damage. In a preferred embodiment, both the at least one handle portion 104 and the body 102 are of a heat resistant material because, in such an embodiment, the at least one handle portion 104 may also contact a heated cooking surface of a pan, as can be seen particularly well in FIG. 6. In one embodiment, the at least one handle portion 104 and the body 102 are integrally made of the same heat resistant material, such as by injection molding or other known manufacturing processes. Advantageously, such embodiments provide lower manufacturing costs due to the elimination of the need to make a separate handle piece and to subsequently attach the handle piece to a main body. In alternative embodiments, the at least one handle portion 104 and the body 102 may be made of different materials.

Referring now to FIGS. 1-4, the shape of the body 102 is shown in detail. In one embodiment, the body 102 may be circular or substantially circular in shape to conform to traditional pans. In other embodiments, the body 102 may be shapes other than circular in shape, including, but not limited to, triangular, rectangular, quadrangular, and the like. In a preferred embodiment, the body 102 may be sized and shaped to be housed within a cooking surface 302. As used herein, “cooking surface” includes, but is not limited to, pans, skillets, griddles, oven trays, and the like, and includes, but is not limited to, various dimensions and measurements, such as 10″, 11″, 12″, and 14″ pans. In a preferred embodiment, the cooking surface 302 may measure approximately 10″ in diameter, and the body 102 may measure approximately 9.25″ from one handle portion 104 to another handle portion 104.

Referring still to FIGS. 1-4, the structure of the body 102 is shown in detail. In one embodiment, the body 102 may be made of a flexible material. As used herein, “flexible material” means capable of conforming to the shape of the cooking surface. In one embodiment, the body 102 may be operably configured to conform to the shape of the cooking surface 302. For example, the cooking surface 302 may be flat, curved, parabolic, or of another shape. As such, the body 102 may be operably configured to directly contact the cooking surface 302 regardless of whether the cooking surface 302 is flat, curved, parabolic, or of another shape. Additionally, the flexibility of the body 102 and the handle portions 104 can be considered to increase the ease with which users can flip a cooked pancake.

Referring particularly to FIG. 1, in one embodiment, the body 102 may define at least one aperture 110. In another embodiment, the body 102 may define a plurality of apertures 110, and in preferred embodiments, the body 102 may define as many as seven or more apertures 110. In a preferred embodiment, the plurality of apertures 110 may be substantially the same in size and shape. However, it is appreciated that, in other embodiments, the plurality of apertures 110 may be of varying sizes and shapes. In a preferred embodiment, the plurality of apertures 110 may be substantially circular in shape. In other embodiments, the plurality of apertures 110 may be of varying shapes, including, but not limited to, circular, triangular, rectangular, star-shaped, and the like. Each of the plurality of apertures 110 may be considered a through-hole with a top opening through which the user may pour batter and a bottom opening permitting the batter to contact the cooking surface 302 for cooking the batter.

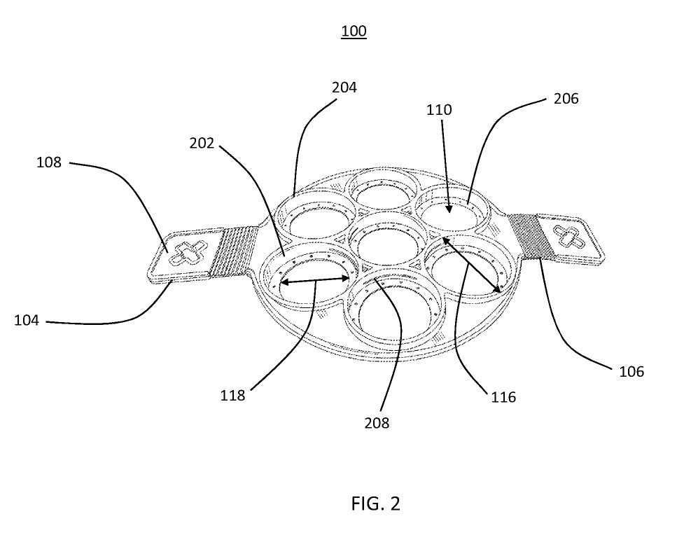

Referring now to FIGS. 1-2, with brief reference to FIG. 4, the aperture 110 is shown in greater detail. For the sake of brevity, the description herein may refer to the aperture 110 in singular form, although it should be understood that the description also applies to the plurality of apertures 110 in plural form. In one embodiment, the aperture 110 may extend from at least the top side 114 of the body 102 through the bottom side 402 of the body 102. In one embodiment, the aperture 110 may include a first diameter 116 defined by a sidewall 202, which may be cylindrical. In one embodiment, the aperture 110 may include a second diameter 118 defined by a lip 206. The lip 206 may be mechanically coupled to the sidewall 202. In a preferred embodiment, the second diameter 118 is less than the first diameter 116.

Referring now to FIGS. 1-4, the sidewall 202 is shown in greater detail. In one embodiment, the sidewall 202 may measure between 0.5″ and 0.75″ in depth. In other embodiments, the sidewall 202 may have a depth outside of this range, but should still be sized to receive batter therein for pancakes and therefore should have a depth corresponding to (or a little deeper) than a thickness of a standard pancake. In one embodiment, the sidewall 202 may include an optimal content marking 208 that advantageously may indicate an optimum level of the batter 304 to be received within the aperture 110 for cooking and flipping. As used herein, “optimal content marking” means a line, other mark, or raised portion that indicates the ideal amount of the batter 304 received within the aperture 110, such as a fill line.

In one embodiment, the pancake flipper 100 may include a rim 204 extending from the top side 114 of the body 102. In other embodiments, the rim 204 may be co-planar with the top side 114 of the body 102, or the rim 204 may be disposed below the top side 114 of the body 102. In one embodiment, the lip 206 may extend from the bottom side 402 of the body 102. In another embodiment, the lip 206 may be co-planar with the bottom side 402 of the body 102.

In one embodiment, the lip 206 may extend inward of the sidewall 202 so as to mechanically support at least a portion 306 of the batter 304 on the lip 206 for flipping. Advantageously, this differentiates from existing shapers that do not provide a support surface to support a cooked substance for flipping. In a further embodiment, when the sidewall 202 is be formed as a cylindrical sidewall 202, the lip 206 may be considered to extend radially inward of the cylindrical sidewall 202 to mechanically support the at least a portion 306 of the batter 304 on the lip 206 for flipping. In other embodiments, the sidewall 202 may be formed as other shapes (e.g., star-shaped, heart-shaped, etc. to provide for different shaped pancakes) and the lip 206 should generally extend inwardly of the sidewall 202 along a bottom end of the sidewall 202, preferably in a generally continuous manner, as depicted in the exemplary embodiment shown in the figures. In other embodiments, the lip 206 may be slightly discontinuous such as, for example, two lip halves separated by a gap therebetween, but should still provide sufficient surface area support to support flipping the pancake shaped by the sidewall 202.

Referring now to FIGS. 1-3, the aperture 110 may be sized and shaped to receive a batter 304 therein. As used herein, “batter” means a consumable substance, whether in solid, liquid, or semi-liquid form, including, but not limited to, pancake batter, eggs, shredded potatoes, cookie dough, and other consumable substances. In a preferred embodiment, the batter 304 may be raw pancake batter. In one embodiment, the aperture 110 may be operably configured to frictionally or mechanically support the at least a portion 306 of the batter 304 on the lip 206, such that the at least a portion 306 of the batter 304 may not directly contact the cooking surface 302. As such, the aperture 110 may provide for the easy and efficient release of flipped batter 304, since the batter 304 is at least partially supported on the lip 206. In one embodiment, the lip 206 may define at least one aerator hole 112 that is sized and shaped to create a heat path therethrough from the cooking surface 302 to the at least a portion 306 of the batter 304 supported on the lip 206, thereby cooking the at least a portion 306 of the batter 304 supported on the lip 206. In one embodiment, the lip 206 may define a plurality of aerator holes 112. In a further embodiment, each of the plurality of aerator holes 112 are disposed at equally spaced apart intervals along the lip 206.

Referring now to FIGS. 1-4, the at least one handle portion 104 is shown in detail. In one embodiment, the pancake flipper 100 may include two handle portions 104. In one embodiment, each of the two handle portions 104 may be made of a flexible material. In one embodiment, each of the two handle portions 104 may be made of a heat resistant material. In a preferred embodiment, the two handle portions 104 and the body 102 are made of the same heat resistant material, making it easy for a user to handle, clean, and maintain the pancake flipper 100. In a preferred embodiment, the heat resistant material is non-stick silicone, which allows the pancake flipper 100 to be safely used in a dishwasher, microwave, oven, and freezer, and which allows a user to easily and efficiently release flipped batter 304 after one side of the batter 304 is sufficiently cooked.

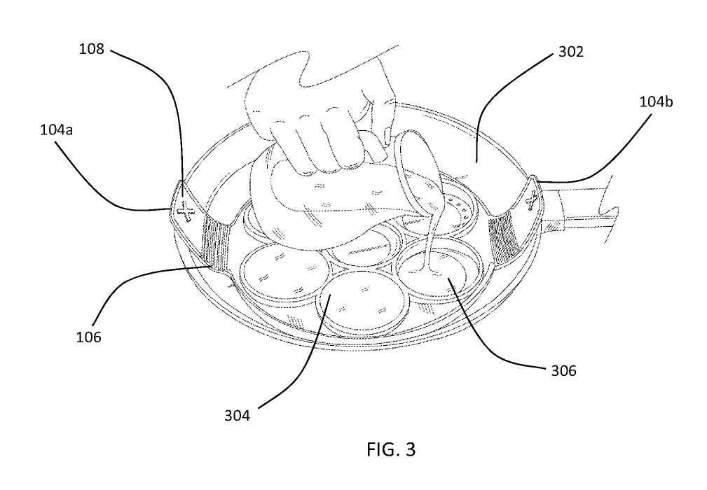

Referring particularly to FIG. 3, in a preferred embodiment, the pancake flipper 100 may include a first handle portion 104a and a second handle portion 104b. In one embodiment, the at least one handle portion 104 may include a hinged portion 106 coupled to the body 102. In one embodiment, the hinged portion 106 advantageously allows each of the handle portions 104 to be flexible, such that the handle portions 104 extend along the sides of cooking surface 302, thereby positioning the handle portions 104 away from the cooking surface 302.

Referring again to FIGS. 1-4, in one embodiment, the handle portion 104 may include a terminal distal gripping portion end 108 opposite the hinged portion 106. In one embodiment, the terminal distal gripping portion end 108 may include a cutout portion, allowing a user to easily grip the terminal distal gripping portion end 108 during use, or to easily hang and store the pancake flipper 100 during nonuse. In a preferred embodiment, a user can grip the terminal distal gripping portion end 108 of each of the two handle portions 104 to use the pancake flipper 100 without contacting the cooking surface 302, thereby increasing the user's safety while using the pancake flipper 100.

In one embodiment, the at least one handle portion 104 may be formed as a flexible flap hingedly coupled to the body 102 on opposing lateral sides of the body 102. In another embodiment, the at least one handle portion 104 is sufficiently flexible to conform to the shape of the cooking surface 302, as shown in FIG. 4. In such embodiments, once the pancake flipper 100 is positioned within the pan, the handle portions 104 may be sized to rest on the sidewalls of the pan and extend slightly above the sidewall of the pan (when the body 102 is laid in the pan) so as to permit the user to grip the terminal distal gripping portion end 108 with his/her fingertips, without touching the hot surface of the pan.

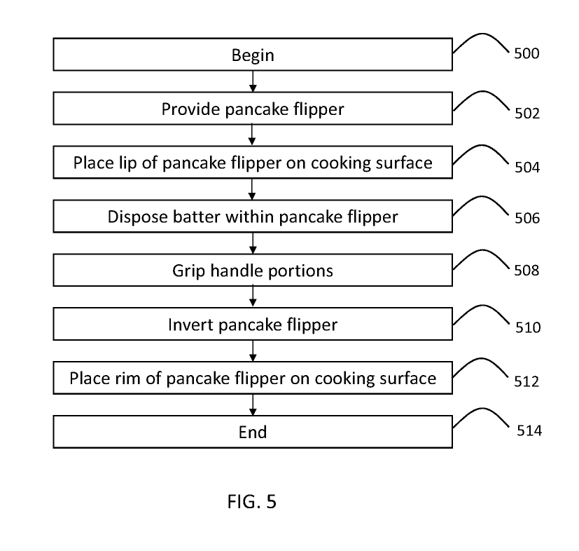

FIGS. 1-4 and 6-9 will be described in conjunction with the process flow chart of FIG. 5. Although FIG. 5 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 5 for the sake of brevity. In some embodiments, some or all of the process steps included in FIG. 5 can be combined into a single process.

Referring now to FIG. 5 in particular, with reference to FIGS. 1-4 and 6-9, a method of using a pancake flipper 100 is described in greater detail. The method of using the pancake flipper 100 begins at step 500 and proceeds directly to step 502, in which the pancake flipper 100 is provided with the features and configurations described herein above. The method of using the pancake flipper 100 may then proceed to step 504, which includes placing the pancake flipper 100 on a cooking surface 302, such that at least a portion of the lip 206 of the aperture 110 directly contacts the cooking surface 302. In one embodiment, substantially the entirety of the lip 206 of the aperture 110 directly contacts and is supported on the cooking surface 302. Steps 502 and 504 are shown in greater detail in FIG. 6.

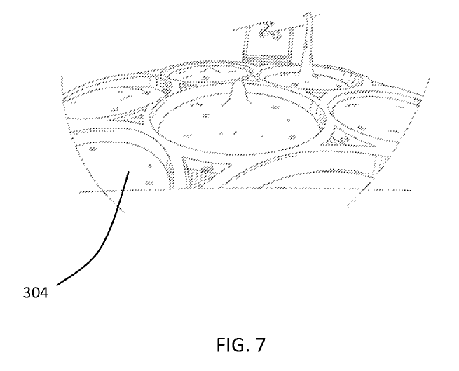

The method of using the pancake flipper 100 may continue to step 506, which is shown in greater detail in FIGS. 6-7, in conjunction with FIG. 5. In step 506, batter 304 may be disposed within the aperture 110. In other words, the batter 304 may be poured within the aperture 110 by the user. In one embodiment, at least a portion 306 of the batter 304 may be supported on the lip 206 of the aperture 110, and the portion 306 of the batter 304 may be partially cooked when heat from the cooking surface 302 is directed through at least one aerator hole 112 defined by the lip 206. Advantageously, since at least a portion 306 of the batter 304 may be supported on the lip 206 of the aperture 110, partially cooked batter 304 may be easily rotated, or flipped, when desired, because not all of the batter 304 is disposed directly on the cooking surface 302.

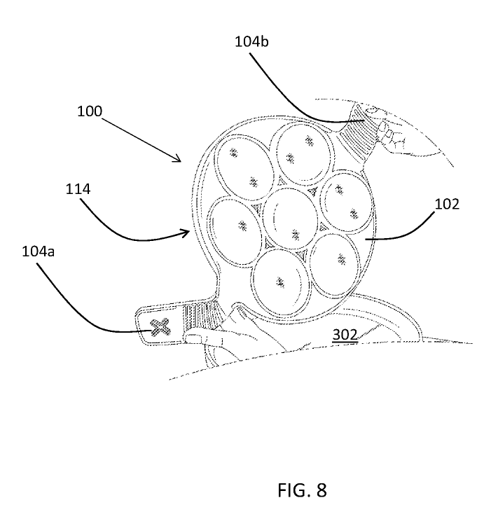

Referring particularly to FIG. 8, in conjunction with FIG. 5, when the batter 304 is sufficiently cooked on one side, the method of using the pancake flipper 100 may continue to step 508. In step 508, a user may grip the handle portions 104 of the pancake flipper 100, either by hand, glove, or by using a kitchen instrument, such as tongs and the like. Preferably, the handle portions 104 are formed of a non-heat conductive material so as to allow the user to easily grip the handle portions 104 with his/her fingers for easy and convenient flipping. The method of using the pancake flipper 100 may then proceed directly to step 510, in which the pancake flipper 100 may be inverted, or flipped, about a longitudinal axis 120 (see FIG. 1), defined by the two handle portions 104. In a preferred embodiment, the user may lift the pancake flipper 100 above the cooking surface 302 and invert the pancake flipper 100 such that the top side 114 of the body 102 now faces the cooking surface 302 to cook the other side of the pancake.

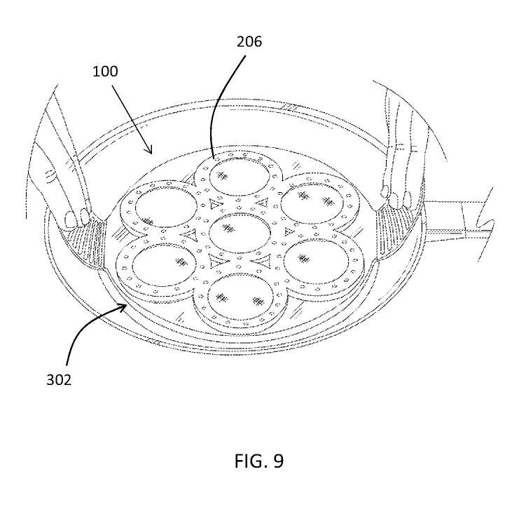

The method of using the pancake flipper 100 may then proceed to step 512, which is shown in greater detail in FIG. 9, in conjunction with FIG. 5. In step 512, the pancake flipper 100 may again be placed on the cooking surface 302. In a preferred embodiment, the pancake flipper 100 may be placed on the cooking surface 302 in a rotated, or flipped, configuration, such that at least a portion of the rim 204 of the aperture 110, as opposed to the lip 206 of the aperture 110, may directly contact the cooking surface 302. As such, the reverse side of the batter 304 may be cooked in this configuration. In step 512, the batter 304 may be released directly onto the cooking surface 302 and the pancake flipper 100 may then be removed from the cooking surface 302. Alternatively, the pancake flipper 100 may remain in contact with the cooking surface 302 while the uncooked side of the batter 304 is cooked. The method of using the pancake flipper 100 may end at step 514.

A pancake flipper and a method of use has been disclosed that can support and frictionally or mechanically retain a batter, and that can be rotated, or flipped, about a longitudinal axis defined by an elongated direction of the body of the pancake flipper from a first handle portion to a second handle portion, providing for an efficient and effective method of flipping batter to cook both sides of the batter.

1. A one-piece pancake flipper comprising:
a body of a flexible material, the body being circular having a diameter corresponding to a diameter of a cooking surface of a cooking pan, and:
including a top side and a bottom side opposite the top side; and
defining seven apertures extending from at least the top side through the bottom side, the seven apertures of the same size and arranged with one aperture in the center of the body with six apertures surrounding the one aperture in the center, and each aperture configured to receive a batter therein and each aperture having:
a first diameter defined by a cylindrical sidewall; and
a second diameter defined by a lip mechanically coupled to the cylindrical sidewall at the bottom side, the second diameter being less than the first diameter; and
wherein the topside is configured to conform to the a shape of the cooking surface while batter is contained with the seven apertures, and wherein the top side is likewise configured to conform to the shape of the cooking surface upon the one-piece pancake flipper being flipped over with the batter contained in the seven apertures and the batter being partially cooked and solidified;
at least a first handle portion of the flexible material and a second handle portion of the flexible material, each of the first handle portion and the second handle portion:
continuously formed with the body;
extending from opposing sides of the body; and
having a length such that at least a portion of a gripping portion at a distal end of each handle portion extends above a sidewall of the cooking pan when the body is placed on the cooking surface of the cooking pan.

2. (canceled)

3. The one-piece pancake flipper of claim 1, wherein:
the body, the first handle portion, and the second handle portion are each made of a heat resistant material.

4. The one-piece pancake flipper of claim 3, wherein:
the heat resistant material is non-stick silicone.

5. The one-piece pancake flipper of claim 1, wherein:
first handle portion and the second handle portion:
is operably configured to contact the cooking surface at the respective hinged portion and extend away from the cooking surface at the respective terminal distal gripping portion end.

6. The one-piece pancake flipper of claim 1, wherein:
the lip extends radially inward of the cylindrical sidewall.

7. The one-piece pancake flipper of claim 1, wherein the cylindrical sidewall further comprises:
an optimal content marking indicating an optimum level of the batter to be received within the at least one aperture for cooking and flipping.

8. The one-piece pancake flipper of claim 1, further comprising:
a rim extending from the top side of the body;
wherein the lip extends from the bottom side of the body.

9. The one-piece pancake flipper of claim 1, wherein the lip:
is disposed to mechanically support at least a portion of the batter thereon; and defines at least one aerator hole sized and shaped to create a heat path therethrough from a cooking surface to the at least a portion of the batter supported on the lip.

10. The one-piece pancake flipper of claim 1, wherein:
each of the first handle portion and the second handle portion are operably configured so that, when flexed, parts of the first handle portion and the second handle portion selectively and alternatively extend above the top side of the body and below the bottom side of the body.

11. A one-piece pancake flipper comprising:
a body of a flexible material, the body being circular having a diameter that is within three quarters of an inch of a diameter of a cooking surface of a cooking pan, and:
including a top side and a bottom side opposite the top side;
defining a plurality of apertures extending from at least the top side through the bottom side, each of the plurality of apertures sized and shaped to receive a batter therein and having:
a first diameter defined by a cylindrical sidewall; and
a second diameter defined by a lip at the bottom side, the second diameter being less than the first diameter, the lip:
extending inward of the cylindrical sidewall; and
extending from the bottom side of the body; and
wherein the topside is configured to conform to the a shape of the cooking surface while batter is contained with the at least one aperture, and wherein the top side is likewise configured to conform to the shape of the cooking surface upon the one-piece pancake flipper being flipped over with the batter contained in the at least one aperture and the batter being partially cooked and solidified;
including a rim extending from the top side of the body; and
a first handle portion of the flexible material and a second handle portion of the flexible material, the first handle portion and the second handle portion:
continuously formed with the body;
extending from opposite sides of the body;
including a hinged portion adjacent to the body; and
including a terminal distal gripping portion end opposite the hinged portion
wherein each of the first and second handle portions has a length such that at least a portion of the distal terminal gripping portion extends above a sidewall of the cooking pan when the body is placed on the cooking surface of the cooking pan.

12. (canceled)

13. The one-piece pancake flipper of claim 11, wherein:
the body, the first handle portion, and the second handle portion are each made of a heat resistant flexible material.

14. The one-piece pancake flipper of claim 13, wherein:
the heat resistant flexible material is non-stick silicone.

15. The one-piece pancake flipper of claim 11, wherein:
the cylindrical sidewall measures between 0.5″ and 0.75″ in depth.

16. The one-piece pancake flipper of claim 11, wherein:
the cylindrical sidewall further includes an optimal content marking indicating an optimum level of the batter to be received within at least one of the plurality of apertures for cooking and flipping.

17. The one-piece pancake flipper of claim 11, wherein:
the lip is disposed to mechanically support at least a portion of the batter thereon.

18. The one-piece pancake flipper of claim 17, wherein:
the lip defines a plurality of aerator holes, each of the plurality of aerator holes sized and shaped to create a heat path therethrough from a cooking surface the at least a portion of the batter supported on the lip.

19. The one-piece pancake flipper of claim 11, wherein:
each of the first handle portion and the second handle portion are formed as a flexible flap on opposing lateral sides of the body.

20. A method of using a one-piece pancake flipper comprising:
providing a one-piece pancake flipper including:
a body of a flexible material, the body:
including a top side and a bottom side opposite the top side;
defining a plurality of apertures extending from at least the top side through the bottom side, each of the plurality of apertures sized and shaped to receive a batter therein and having:
a first diameter defined by a cylindrical sidewall; and
a second diameter defined by a lip, the second diameter being less than the first diameter, the lip:
extending inward of the cylindrical sidewall; and
extending from the bottom side of the body; and
including a rim extending from the top side of the body; and
a first handle portion of the flexible material and a second handle portion of the flexible material, the first handle portion and the second handle portion:
continuously formed with the body;
extending from opposite sides of the body;
including a hinged portion adjacent to the body; and
including a terminal distal gripping portion end opposite the hinged portion;
placing the one-piece pancake flipper on the cooking surface, such that at least a portion of the lip directly contacts the cooking surface;
disposing the batter within at least one of the plurality of apertures, at least a portion of the batter being supported on the lip;
gripping the first handle portion and the second handle portion;
rotating the one-piece pancake flipper about a longitudinal axis to place the pancake flipper in an inverted position; and
placing the one-piece pancake flipper on the cooking surface, such that at least a portion of the rim directly contacts the cooking surface.
